(19) United States
(12) Patent Application Publication
(10) Pub. No.: US 2011/0044166 A1
(43) Pub. Date: Feb. 24, 2011

(54) METHOD FOR OPERATING NODE IN ETHERNET RING NETWORK

(75) Inventors: Sang-Min LEE, Daejeon (KR); Jeong-dong RYOO, Daejeon (KR); Daeub KIM, Daejeon (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/858,862

(22) Filed: Aug. 18, 2010

(30) Foreign Application Priority Data
Aug. 18, 2009 (KR) 10-2009-0076184
Jun. 1, 2010 (KR) 10-2010-0051833

(51) Int. Cl. G08C 15/00

(52) U.S. Cl. 370/223

(57) ABSTRACT

A ring protection link (RPL) owner node in a ring network transmits a ring-automatic protection switching (R-APS) frame in a burst mode until blocked ports of all nodes except the RPL owner node have been unblocked, and, if it is determined that all the nodes have been unblocked, transmits the R-APS frame in a continuous mode. In this manner, the time required to unblock all the nodes can be reduced.

### CROSS-REFERENCE TO RELATED APPLICATION

This application claims priority to and the benefit of Korean Patent Application Nos. 10-2009-0076184 and 10-2010-0051833 filed in the Korean Intellectual Property Office on Aug. 18, 2009 and Jun. 1, 2010, the entire contents of which are incorporated herein by reference.

### BACKGROUND OF THE INVENTION

(a) Field of the Invention

The present invention relates to a method for operating a node in an Ethernet ring network.

(b) Description of the Related Art

Ethernet network technology is emerging as the leading technology to replace the Synchronous Digital Hierarchy (SDH)/Synchronous Optical NETwork (SONET). Thus, the development and standardization of Ethernet ring protection switching technologies are actively underway.

In a ring network, a ring is configured by connecting a port of each node to a port of a neighboring node, and a predetermined specific port among ports of the ring is logically blocked to prevent formation of a loop. That is, one of a plurality of nodes of the ring network is designated as a ring protection link (RPL) owner node, and the RPL port of the RPL owner node is blocked to prevent loop generation. Here, a blocked port is physically connected but logically blocked. When the blocked port is unblocked, traffic can be forwarded immediately.

In the ring network, the nodes of the ring network have to be initialized in order to enable traffic forwarding. The initialization is done when all the nodes of the ring network receive a ring-automatic protection switching (R-APS) frame. That is, when the Ethernet ring protection switching function is started, all the nodes except the RPL owner node perform initialization by an operation of blocking a port and then unblocking the other port.

At this point, the RPL owner node generates a ring-automatic protection switching (R-APS) frame and transmits it to a neighboring node, and the neighboring node having received the R-APS frame unblocks a blocked port by an Ethernet ring protection switching operation. However, the neighboring node having received the R-APS frame can unblock a blocked port, but cannot forward the R-APS frame to another neighboring node. Therefore, after the unblocking is done, the neighboring node receives another R-APS frame transmitted from the RPL owner node in the next interval and then transmits it to another neighboring node through the unblocked port, and the other neighboring node having received the R-APS frame unblocks a blocked port. That is, one R-APS frame allows for unblocking of only one node. Since the other nodes except the RPL owner node are unblocked in this manner, it takes a long time to unblock the nodes if the number of nodes of the ring network is increased.

Moreover, the R-APS frame has, as transmission modes, a burst mode for continuously transmitting three frames within a maximum of 3.3 msec and a continuous mode for transmitting a frame periodically every five seconds, and its transmission is carried out in the continuous mode after the burst mode. That is, the RPL owner node continuously transmits the first three R-APS frames, and after that, transmits an R-APS frame every five seconds. Accordingly, the greater the number of nodes of the ring network, the longer it takes to unblock the nodes.

Moreover, the RPL owner node cannot precisely determine whether preparation for traffic transmission is complete unless it precisely detects the time required to unblock blocked ports of the nodes.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for operating a node in an Ethernet ring network, which can reduce the time required to unblock blocked ports of all other nodes except an RPL owner node in the ring network in order to perform traffic transmission.

An exemplary embodiment of the present invention provides a method for operating a ring protection link (RPL) owner node in a ring network. This operating method includes: transmitting a ring-automatic protection switching (R-APS) frame in a burst mode through an RPL port and a port other than the RPL port; receiving the R-APS frame from a neighboring node; and transmitting the R-APS frame in a continuous mode after receiving the R-APS frame.

Another exemplary embodiment of the present invention provides a method for operating a plurality of nodes in a ring network, wherein each of the nodes has two ports connecting the ring network. This operating method includes: blocking at least one of the two ports; receiving a first R-APS frame among a plurality of R-APS frames through one of the two ports; unblocking the two ports; receiving a second R-APS frame among the plurality of R-APS frames through one of the two unblocked ports; and forwarding the second R-APS frame to a neighboring node through the other of the two unblocked ports, wherein the node having received the second R-APS frame unblocks the two ports, and the plurality of R-APS frames are transmitted in a burst mode from an ring protection link (RPL) owner node of the ring network until both of the blocked ports of each of the plurality of nodes are unblocked.

Still another exemplary embodiment of the present invention provides a method for operating a ring protection link (RPL) owner node in a ring network. This operating method includes: transmitting a plurality of ring-automatic protection switching (R-APS) frames in a burst mode; determining whether the ports of each of all other nodes except the RPL owner node in the ring network are unblocked; and if it is determined that all the nodes have been unblocked, transmitting R-APS frames in a continuous mode, wherein the transmission interval of the burst mode is shorter than the transmission interval of the continuous mode.

According to the exemplary embodiments of the present invention, it is possible to reduce the time required to unblock blocked ports of the other nodes except the RPL owner node in the ring network. Moreover, the RPL owner node can easily determine whether preparation for traffic transmission is complete.

### BRIEF DESCRIPTION OF THE DRAWINGS

FIG. 1 is a view showing a ring network according to one exemplary embodiment of the present invention.

FIG. 2 is a block diagram of a node shown in FIG. 1.

FIG. 3 is a view showing a method for operating a node in a ring network according to an exemplary embodiment of the present invention.

FIGS. 4A to 4F are views showing the states of the ports of nodes in each step shown in FIG. 3.

FIG. 5 is a view showing a method for transmitting an R-APS frame according to an exemplary embodiment of the present invention.

FIG. 6 is a flowchart showing a method for operating a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Now, a method for operating a node in an Ethernet ring network according to an exemplary embodiment of the present invention will be described in detail with reference to the drawings.

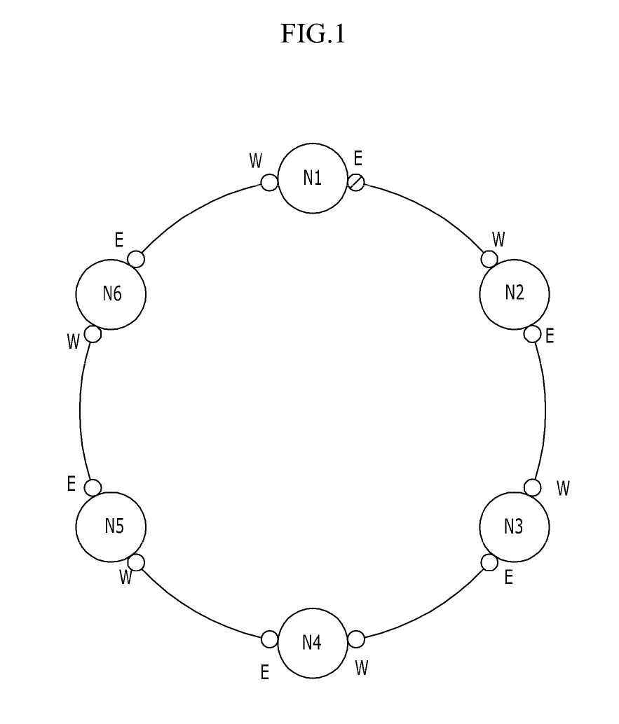

FIG. 1 is a view showing a ring network according to one exemplary embodiment of the present invention.

Referring to FIG. 1, a ring network includes a plurality of nodes N1-N6 connected in a ring shape. Each node N1-N6 includes two ports E and W connecting the ring network, and the port E of each node N1-N6 is connected to the port W of a node N2-N6 and N1 neighboring in one direction, for example, clockwise, thereby configuring a ring. Also, each node N1-N6 can further include other ports in addition to the two ports connecting the ring network. At this time, the other ports may be connected to an external Ethernet network. FIG. 1 shows only the two ports E and W connecting the ring network. The node N1 can be designated as an RPL owner node. Hereinafter, the node N1 is referred to as the RPL owner node N1, and the port E of the RPL owner node N1 is referred to as an RPL port E.

The RPL owner node N1 logically blocks the RPL port E to prevent the formation of a loop in the ring network. When a fault occurs, the port with the fault is blocked. Thus, the RPL owner node N1 may unblock the RPL port E.

For the Ethernet ring protection switching function, initialization has to be done first. Upon receipt of a start signal of the Ethernet ring protection switching function, the RPL owner node N1 blocks only the RPL port E among the two ports E and W, and at the same time the other nodes N2-N6 except the RPL owner node N1 block both of the ports E and W. Afterwards, the RPL owner node N1 transmits an R-APS frame through the RPL port E and the port W, and the nodes N2, N6, N3, N5, and N4 receiving the R-APS frame through the blocked ports W and E unblock the ports E and W. In this way, the initialization of the nodes N1-N6 is completed by blocking and unblocking processes. When the initialization of the nodes N1-N6 is complete, data frame transmission is enabled.

On the other hand, upon receipt of a start signal of the Ethernet ring protection switching function, the RPL owner node N1 may block only the RPL port E among the two ports E and W, and the other nodes N2-N6 except the RPL owner node N1 may block only one of the two ports E and W.

In general, a data frame cannot be received by a blocked port. However, this blocking involves logical blocking rather than physical blocking with a signal failure, so a control frame can be received through a blocked port. For example, an R-APS frame or an OAM frame, which is a frame for Ethernet operation, administration, and maintenance (OAM), can be received through a blocked port. However, even though a control frame is received through a blocked port, the control frame is not forwarded to a neighboring node through the blocked port.

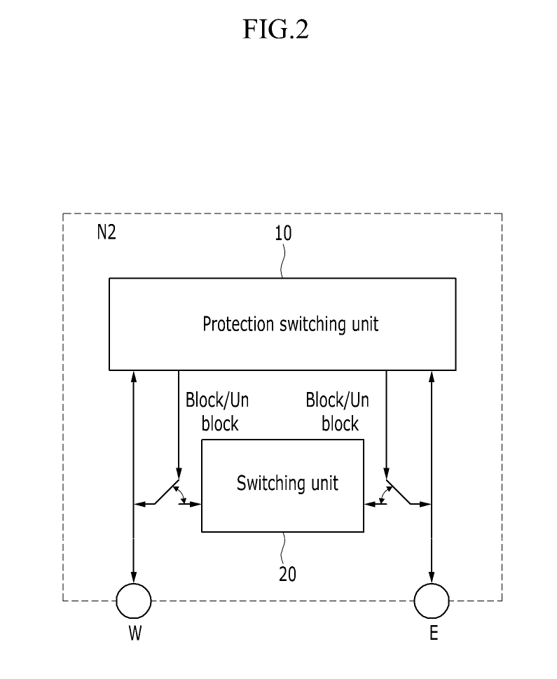

FIG. 2 is a block diagram of a node shown in FIG. 1. FIG. 2 illustrates only one node N2 among the nodes N1-N2 shown in FIG. 1, and the other nodes N1 and N3-N6 may be configured in the same manner as the node N2 and may perform a similar or the same function as the node N2.

Referring to FIG. 2, the node N2 includes ports E and W, a protection switching unit 10, and a switching unit 20.

Upon receipt of an R-APS frame through one port E or W among the ports E and W, the protection switching unit 10 may block the two ports E and W or unblock the two ports E and W. The protection switching unit 10 of the RPL owner node N1 may additionally perform the function of allowing the other nodes N2-N6 to transmit an R-APS frame in a burst mode during initialization until both of the ports E and W are unblocked and allowing the other nodes N2-N6 to transmit an R-APS frame in a continuous mode when the unblocking of the two ports E and W is complete.

The switching unit 20 forwards the R-APS frame received through one port E or W among the ports E and W to a neighboring node, for example, the node N3 through the other port W or E. It is to be noted that the R-APS frame can be forwarded only through an unblocked port.

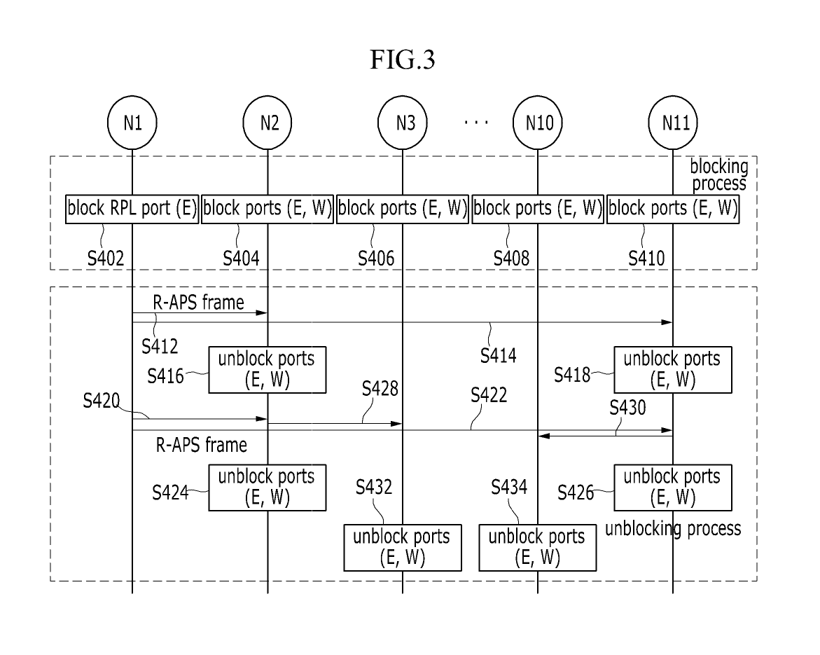

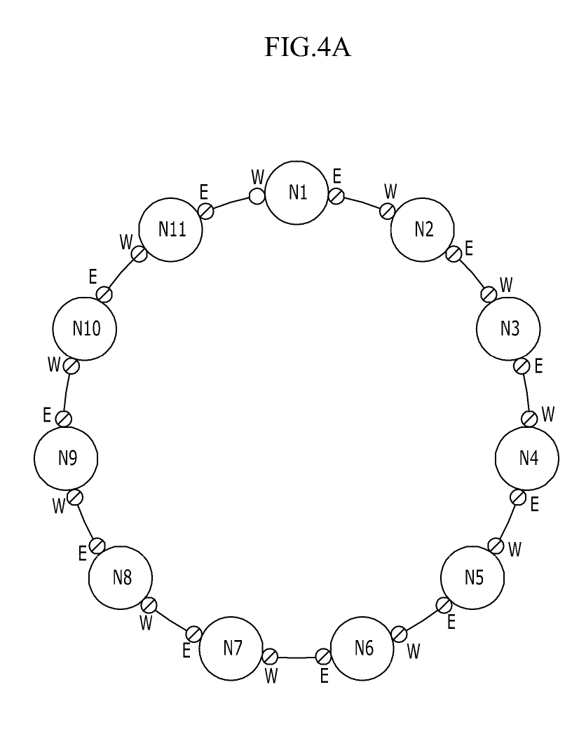

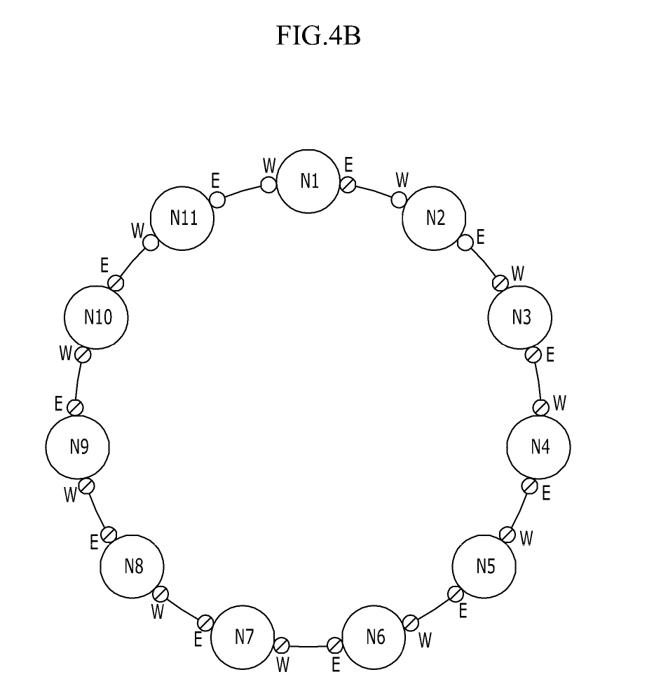

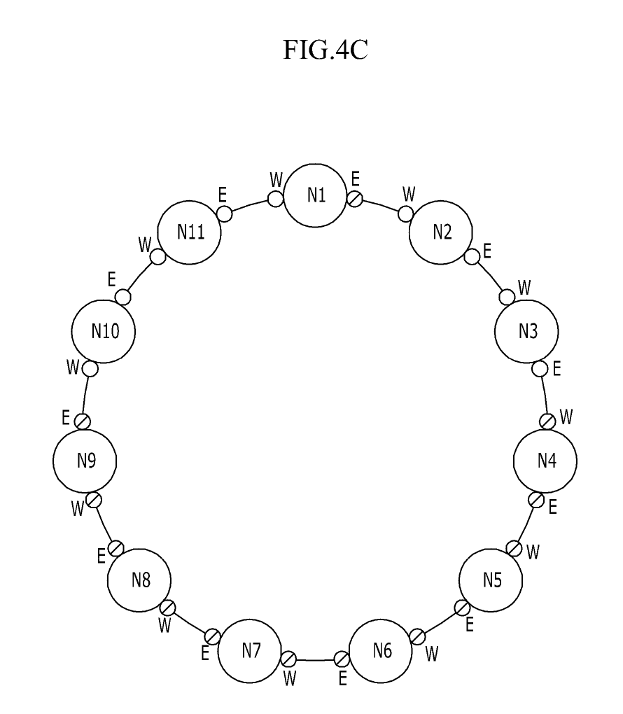

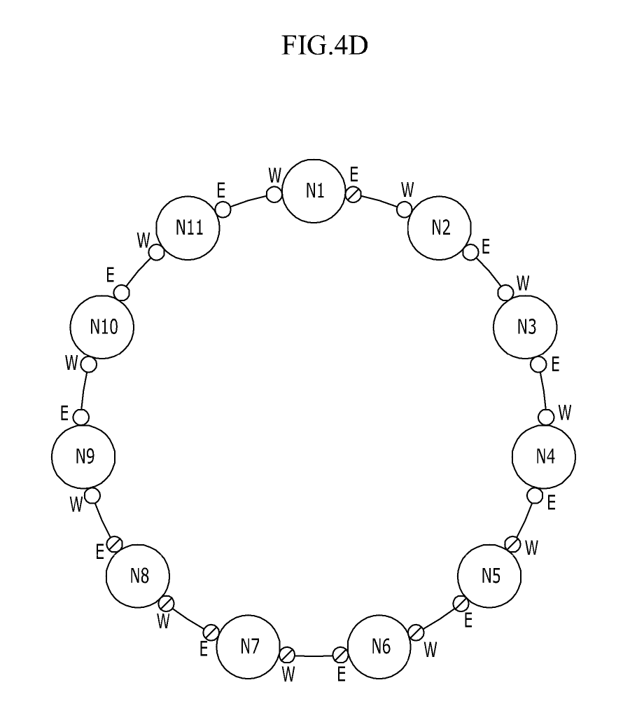

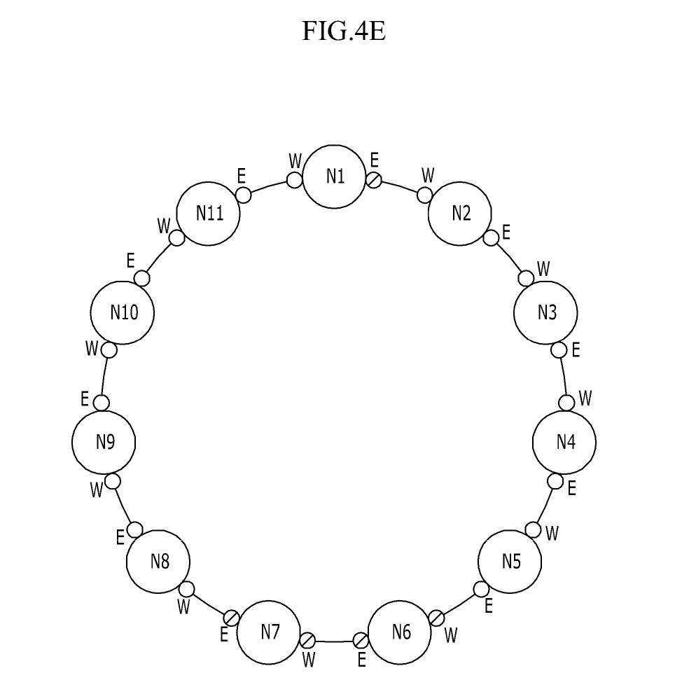

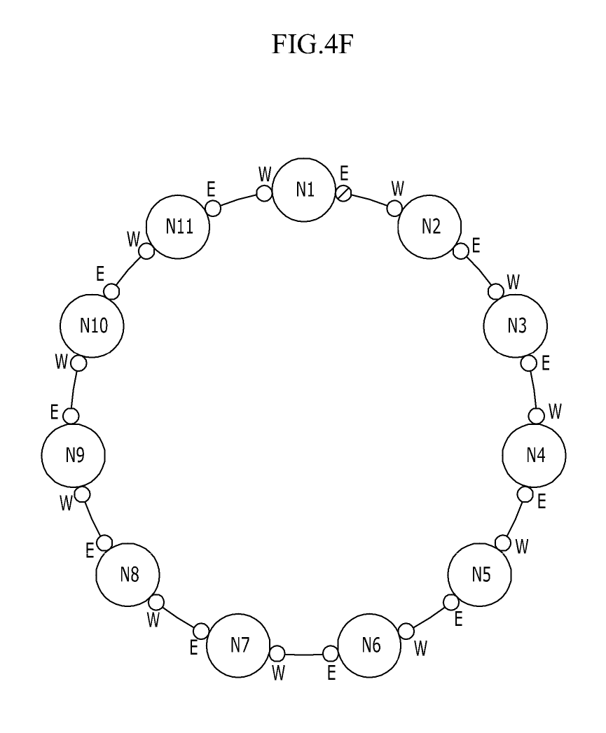

FIG. 3 is a view showing a method for operating a node in a ring network according to an exemplary embodiment of the present invention, and FIGS. 4A to 4F are views showing the states of the ports of nodes in each step shown in FIG. 3. FIG. 3 and FIGS. 4A to 4F illustrate that there are eleven nodes N1-N11 in a ring network, and the node N1 is an RPL owner node N1.

Referring to FIG. 3, to start the Ethernet ring protection switching function, initialization has to be done first. Upon receipt of a start signal of the Ethernet ring protection switching function, the RPL owner node N1 blocks only the RPL port E, and the nodes N2 and N11 block both of the ports E and W (5404-5410). That is, the ports E and W of the RPL owner node N1 and the ports E and W of the nodes N2 and N11 become as shown in FIG. 4A.

In the state shown in FIG. 4A, initialization can be completed by unblocking both of the ports E and W of the nodes N2 and N11.

The RPL owner node N1 forwards a first R-APS frame to neighboring nodes N2 and N11 through the RPL port E and the port W (S412 and S414). Then, the nodes N2 and N11 receive the R-APS frame through the blocked ports W and E. Having received the R-APS frame, the nodes N2 and N11 unblock the two ports E and W by using the R-APS frame (S416 and S418). That is, the ports E and W of the RPL owner node N1 and the ports E and W of the nodes N2 and N11 become as shown in FIG. 4B. Since the nodes N2 and N11 have received the R-APS frame when the two ports E and W are in a blocked state, the nodes N2 and N11 cannot forward the R-APS frame to neighboring nodes N3 and N10, respectively, through the ports E and W.

Subsequently, the RPL owner node N1 forwards a second R-APS frame to the neighboring nodes N2 and N11 through the RPL port E and the port W (S420 and S422). Having received the second R-APS frame, the nodes N2 and N11 perform an operation of unblocking the two ports E and W (S424-S426). At this point, the ports E and W of the nodes N2 and N11 have already been unblocked, so there is no actual change even if the unblocking operation is performed. Also, because the nodes N2 and N11 have received the R-APS frame when the two ports E and W have been unblocked, the nodes N2 and N11 forward the second R-APS frame to the neighboring nodes N3 and N10 through the opposite ports W and E of the ports E and W that have received the second R-APS frame (S428 and S430).

Having received the second R-APS frame, the nodes N3 and N10 unblock the two ports E and W by using the R-APS frame (S432 and S434). That is, the ports E and W of the RPL owner node N1 and the ports E and W of the nodes N3 and N10 become as shown in FIG. 4C. Since the nodes N3 and N10 as well have received the R-APS when the two ports E and W are in a blocked state, they cannot forward the R-APS frame to neighboring nodes N4 and N9.

In the same manner, when the RPL owner node N1 forwards a third R-APS frame through the RPL port E and the port W, the two ports E and W of the nodes N4 and N9 are unblocked as shown in FIG. 4D, and when the RPL owner node N1 forwards a fourth R-APS frame through the RPL port E and the port W, the two ports E and W of the nodes N5 and N8 are unblocked as shown in FIG. 4E. Also, when the RPL owner node N1 forwards a fifth R-APS frame through the RPL port E and the port W, the two ports E and W of the nodes N6 and N7 are unblocked as shown in FIG. 4F.

With both of the ports E and W of the nodes N2-N11 being unblocked, when the RPL owner node N1 generates a sixth R-APS frame and forwards it through the RPL port E and the port W, the R-APS frame is finally forwarded to the RPL owner node N1 through the nodes N2 and N11. Accordingly, upon receipt of the R-APS frame, the RPL owner node N determines that the unblocking of all the ports of the nodes N2-N11 is complete.

As such, if there are eleven nodes in the ring network, all the nodes are unblocked only when the RPL owner node N1 has to transmit five R-APS frames. In general, the RPL owner node N1 transmits three R-APS frames in the burst mode, and then transmits two R-APS frames in the continuous mode. In the continuous mode, the transmission interval of the R-APS frames is five seconds. Thus, the time required for initialization increases as the number of nodes in the ring network increases.

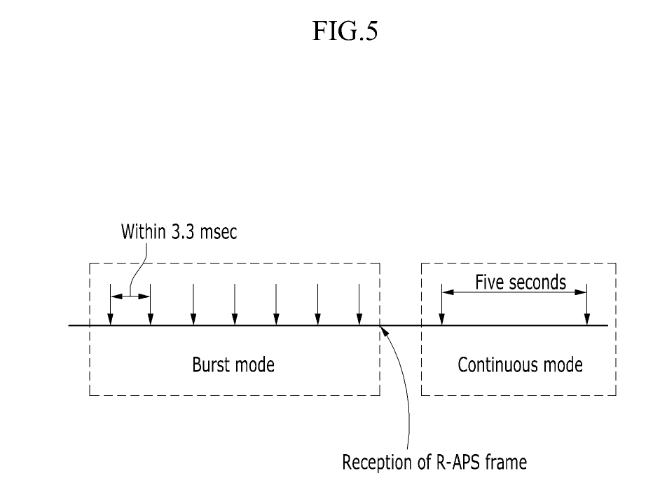

FIG. 5 is a view showing a method for transmitting an R-APS frame according to an exemplary embodiment of the present invention.

Referring to FIG. 5, the RPL owner node N1 according to an exemplary embodiment of the present invention transmits an R-APS frame in the burst mode until all the nodes present in the ring network are unblocked. When all the nodes are unblocked, the RPL owner node N1 switches to the continuous mode. On the other hand, the RPL owner node N1 may transmit an R-APS frame in a combination of the burst mode and the continuous mode until all the nodes present in the ring network are unblocked.

To this end, the RPL owner node N1 has to be able to determine whether all the nodes have been unblocked. Although the R-APS frame can be received through blocked ports, it cannot be forwarded. Thus, the reception of the R-APS frame by the RPL owner node N1 means that the ports of all the nodes have been unblocked. Accordingly, the RPL owner node N1 according to an exemplary embodiment of the present invention determines that all the nodes have been unblocked upon receipt of the R-APS frame transmitted by itself. Having received the R-APS frame, the RPL owner node N1 transmits an R-APS frame in the continuous mode.

In general, the RPL owner node N1 enters an idle state after transmitting an R-APS frame, and the other nodes N2-N6 except the RPL owner node N1 enter the idle state after blocking the two ports and stopping R-APS frame transmission. At this time, the ports of the other nodes N2-N6 in the idle state are blocked, so the nodes N2-N6 cannot transmit a data frame. Incidentally, since the nodes N2-N6 enter the idle state after blocking the two ports, the RPL owner node N1 is unable to determine whether the idle state of the nodes N2-N6 is a state where data transmission is possible or not.

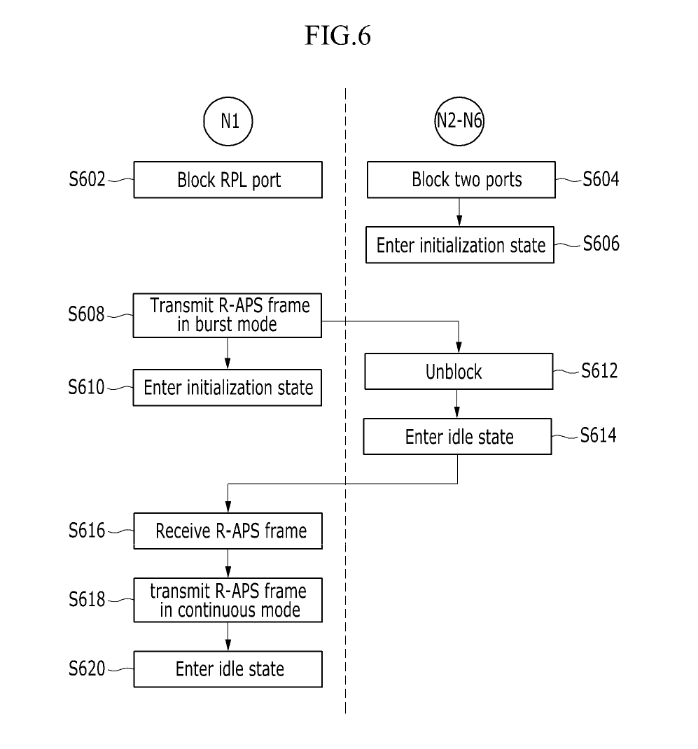

A method of allowing the RPL owner node N1 to determine whether the nodes N2-N6 are ready to transmit a data frame will be described below with reference to FIG. 6.

FIG. 6 is a flowchart showing a method for operating a node according to an exemplary embodiment of the present invention.

Referring to FIG. 6, when the RPL owner node N1 and the nodes N2-N6 receive a start signal of the Ethernet ring protection switching function, the RPL owner node N1 blocks only the RPL port E (S602), and the nodes N2-N6 block both of the ports E and W (S604).

Next, the nodes N2-N6 enter an initialization state (S606).

After that, in order to unblock the ports E and W of the nodes N2-N6, the RPL owner node N1 transmits an R-APS frame in the burst mode (S608), and enters the initialization state (S610). Referring to FIG. 3 and FIGS. 4A to 4F, as explained above, the nodes N2-N6 unblock the ports E and W (S612) and enter the idle state (S614).

The RPL owner node N1 transmits an R-APS frame in the burst mode until the unblocking of the nodes N2-N6 is complete.

When the unblocking of the nodes N2-N6 is complete, the R-APS frame transmitted by the RPL owner node N1 is received again by the RPL owner node N1.

Upon receipt of the R-APS frame (S616), the RPL owner node N1 terminates the burst mode and switches to the continuous mode, and thereafter transmits an R-APS frame in the continuous mode (S618). Next, the RPL owner node N1 enters the idle state (S620). As such, when the RPL owner node N1 enters the idle state, it means that the unblocking of the nodes N2-N6 is complete. Thus, it can be confirmed that all the nodes N2-N6 have been unblocked as the RPL owner node N1 enters the idle state. Consequently, the RPL owner node N1 can determine that the nodes N2-N6 are ready to transmit a data frame.

That is, the state transition of the RPL owner node N1 and the nodes N2-N6 is as shown in Table 1.

TABLE 1

| | input | | |
|---|---|---|---|
| | High-priority | output | |
| Node state | requirements | Actions | State of next node |
| Initialization | Start signal | Stop guard timer | Initialization state |
| state | R-APS | Stop WTR timer | Idle state |
| | | RPL owner node: | |
| | | Unblock ports other than RPL port | |
| | | R-APS forwarding (burst mode) | |
| | | Else: | |
| | | Unblock both ports | |
| | | R-APS transfer is disabled | |
| | | Unblock two ports of each of all other nodes except | |
| | | RPL owner node | |
| | | RPL owner node: | |
| | | R-APS forwarding (continuous mode) | |

That is, in a state where the RPL port E is blocked and the port W other than the RPL port E is not blocked, the RPL owner node N1 transmits an R-APS frame in the burst mode and enters the idle state. The nodes N2-N6 other than the RPL owner node N1 in the ring network block the ports E and W and enter the idle state.

In the above initialization state, the nodes N2-N6 other than the RPL owner node N1 in the ring network unblock the ports E and W and then enter the idle state, and the RPL owner node N1 transmits an R-APS frame in the continuous mode and enters the idle state.

The above-described exemplary embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for operating a ring protection link (RPL) owner node, the method comprising:
transmitting a ring-automatic protection switching (R-APS) frame in a burst mode through an RPL port and a port other than the RPL port;
receiving the R-APS frame from a neighboring node; and
transmitting the R-APS frame in a continuous mode after receiving the R-APS frame.

2. The method of claim 1, wherein the transmission interval of the R-APS frame in the burst mode is shorter than the transmission interval of the R-APS frame in the continuous mode.

3. The method of claim 1, further comprising:
transmitting the R-APS frame in the burst mode and entering an initialization state; and
upon receipt of the R-APS frame, entering an idle state.

4. The method of claim 1, further comprising, upon receipt of the R-APS frame, determining that the ports of the other nodes except the RPL owner node in the ring network have been unblocked.

5. A method for operating a plurality of nodes in a ring network, each of the nodes having two ports connecting the ring network, the method comprising:
blocking at least one of the two ports;
receiving a first R-APS frame among a plurality of R-APS frames through one of the two ports;
unblocking the two ports;
receiving a second R-APS frame among the plurality of R-APS frames through one of the two unblocked ports; and
forwarding the second R-APS frame to a neighboring node through the other of the two unblocked ports,
wherein the node having received the second R-APS frame unblocks the two ports, and
the plurality of R-APS frames are transmitted in a burst mode from an Ring Protection Link (RPL) owner node of the ring network until both of the blocked ports of each of the plurality of nodes are unblocked.

6. The method of claim 5, further comprising, if both of the ports of each of the plurality of nodes are unblocked, receiving the R-APS frames transmitted from the RPL owner in the continuous mode.

7. The method of claim 6, wherein the transmission interval of the burst mode is shorter than the transmission interval of the continuous mode.

8. The method of claim 7, wherein the transmission interval of the burst mode is a maximum of 3.3 milliseconds, and the transmission interval of the continuous mode is five seconds.

9. The method of claim 6, wherein the RPL owner node enters an initialization state after transmission in the burst mode, and enters an idle state after transmission in the continuous mode.

10. The method of claim 5, further comprising entering an initialization state after blocking at least one of the ports.

11. The method of claim 9, further comprising unblocking the two ports and entering an idle state.

12. A method for operating a ring protection link (RPL) owner node in a ring network, comprising:
transmitting a plurality of ring-automatic protection switching (R-APS) frames in a burst mode;
determining whether the ports of each of all other nodes except the RPL owner node in the ring network have been unblocked; and
if it is determined that all the nodes have been unblocked, transmitting R-APS frames in a continuous mode,
wherein the transmission interval of the burst mode is shorter than the transmission interval of the continuous mode.

13. The method of claim 12, wherein the determination further comprises, upon receipt of the R-APS frames from neighboring nodes of the ring network, determining that the unblocking has been done.

14. The method of claim 12, further comprising:
transmitting the R-APS frames in the burst mode and entering an initialization state; and
if it is determined that all the nodes have been unblocked, entering an idle state.

15. The method of claim 12, further comprising:
upon receipt of a start signal of the Ethernet ring protection switching function, blocking an RPL port; and
blocking the ports of all the nodes except the RPL owner node.

16. The method of claim 12, wherein the transmission interval of the continuous mode is a maximum of five seconds, and the transmission interval of the burst mode is 3.3 milliseconds.
